(19) United States
(12) Patent Application Publication
(10) Pub. No.: US 2026/0186973 A1
(43) Pub. Date: Jul. 2, 2026

(54) INCREASED FILE LOADS USING FILE BASED OPTIMIZATION AND PREFETCH WITHIN A MEMORY SYSTEM

(71) Applicant: Micron Technology, Inc., Boise, ID (US)

(72) Inventors: Wenjun Wu, Shanghai (CN); Huachen Li, Shanghai (CN); Yanhua Bi, Shanghai (CN); Xiao Wang, Shanghai (CN); Di Cheng, Shanghai (CN); Xiongjian Wu, Shanghai (CN); Tingting Yue, Shanghai (CN); Zhehong Qu, Shanghai (CN); Fei Chen, Shanghai (CN)

(21) Appl. No.: 19/418,510

(22) Filed: Dec. 12, 2025

Related U.S. Application Data
(60) Provisional application No. 63/739,065, filed on Dec. 26, 2024.

(51) Int. Cl. G06F 12/0862

(52) U.S. Cl. CPC G06F 12/0862; G06F 2212/602

(57) ABSTRACT

Methods, systems, and devices for increased file loads using file based optimization (FBO) and prefetch within a memory system are described. A system may support using a prefetch command to prioritize prefetching for artificial intelligence (AI) related data (or other high priority data). A host system may transmit a prefetch command for the AI-related data before performing one or more AI operations that use the data. In response, the memory system may prefetch the AI-related data and store the data in a cache. The storage of the AI-related data in the cache may be prioritized over other data types associated with lower priorities. The host system may transmit an FBO command to defragment the AI-related data in the memory system prior to the prefetch, which may reduce latency of the prefetch.

### CROSS REFERENCE

The present Application for Patent claims priority to U.S. Patent Application No. 63/739,065 by Wu et al., entitled “INCREASED FILE LOADS USING FILE BASED OPTIMIZATION AND PREFETCH WITHIN A MEMORY SYSTEM,” filed Dec. 26, 2024, which is assigned to the assignee hereof, and which is expressly incorporated by reference in its entirety herein.

### TECHNICAL FIELD

The following relates to one or more systems for memory, including increased file loads using file based optimization and prefetch within a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports increased file loads using file based optimization (FBO) and prefetch within a memory system in accordance with examples as disclosed herein.

FIG. 2 shows an example of an optimization scheme that supports increased file loads using FBO and prefetch within a memory system in accordance with examples as disclosed herein.

FIG. 3 shows an example of a flow diagram that supports increased file loads using FBO and prefetch within a memory system in accordance with examples as disclosed herein.

FIG. 4 shows a block diagram of a memory system that supports increased file loads using FBO and prefetch within a memory system in accordance with examples as disclosed herein.

FIG. 5 shows a flowchart illustrating a method or methods that support increased file loads using FBO and prefetch within a memory system in accordance with examples as disclosed herein.

### DETAILED DESCRIPTION

Some electronic devices may support artificial intelligence (AI) programs, applications, procedures, or the like. Memory systems may store data that supports AI-related applications that are performed by a host system (e.g., a device that supports AI operations). Such AI-related data and corresponding applications may be relatively high priority (e.g., to retrieve) for the host system. Further, such AI-related data may be relatively large, which may increase latency, processing times, and overhead, in some examples, when the data is read from memory. Because the AI-related data may be relatively large and may be stored in a defragmented manner across the memory system, other reads for other types of data may interrupt a read of the AI-related data, thereby increasing latency at the host system.

Techniques described herein support prioritizing prefetching for AI-related data or other high priority data (e.g., data associated with at least a threshold priority value). A host system may transmit a prefetch command for the AI-related data before performing one or more AI operations that use the data. In response, a memory system may prefetch the AI-related data and store the data in a cache (e.g., for temporary use). The storage of the AI-related data in the cache may be prioritized over other data types associated with lower priorities. In some cases, the AI-related data may be maintained in the cache for a longer period of time than other data. Additionally, or alternatively, the host system may transmit a file based optimization (FBO) command to defragment the AI-related data in the memory system. For example, the host system may monitor AI files (e.g., files that include AI-related data) and, if the host system receives an indication that a file is fragmented in the memory system, the host system may send an FBO command that instructs the memory system to move (e.g., transfer) the data so that the file is stored in continuous physical addresses within the memory system. This may reduce latency of the prefetch and read operations.

In addition to applicability in memory systems as described herein, techniques for increased file loads using FBO and prefetch may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by prioritizing prefetching data related to AI or other high priority applications. In this way, the device may reduce latency for executing such applications, which may improve response times, performance, and throughput, among other benefits.

Features of the disclosure are illustrated and described in the context of systems, devices, and circuits. Features of the disclosure are further illustrated and described in the context of an optimization scheme, a flow diagram, and flowcharts.

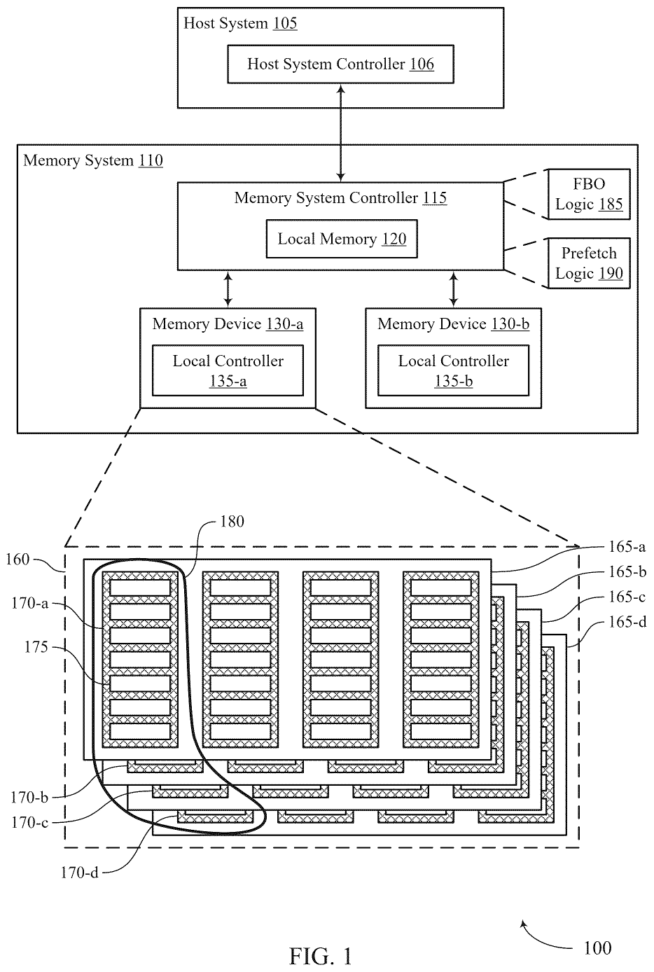

FIG. 1 shows an example of a system 100 that supports increased file loads using FBO and prefetch within a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

The system 100 described herein may support using a prefetch command to prioritize prefetching for AI-related data or other high priority data. A host system 105 may transmit a prefetch command for the AI-related data to prepare for performing one or more AI operations that use or are otherwise associated with the data (e.g., that use the data). In response, a memory system 110 may prefetch, using prefetch logic 190 (e.g., one or more circuits or other logic components configured to facilitate prefetching), the AI-related data and store the data in a cache (e.g., for temporary use) of a memory device 130. For example, the memory system 110 may store the AI-related data in the cache with priority over other data types associated with lower priorities. In some cases, the memory system 110 may maintain the AI-related data in the cache for a longer period of time than other data.

Additionally, or alternatively, the host system 105 may transmit an FBO command to defragment the AI-related data in the memory system 110. For example, the host system 105 may monitor AI files (e.g., files that include AI related data) via communications with the memory system 110 (e.g., one or more requests for storage information). If the host system 105 receives an indication (e.g., from the memory system 110) that a file is fragmented in the memory system 110, the host system 105 may transmit an FBO command that instructs the memory system 110 to transfer (e.g., reorganize) the data so that the file is stored in continuous physical addresses within the memory system 110. In some examples, the memory system 110 may transfer the data so that the file is stored in the continuous physical addresses (e.g., using FBO logic 185). Accordingly, the host system 105 and the memory system 110 may implement prefetch and FBO procedures to reduce latency of the prefetch and read operations.

As described herein, an FBO operation may refer to performing background rearrangement of data within a system such that data within a given write or read can be written or read sequentially instead of fragmented across an array of memory. For example, a host system 105 may transmit one or more commands associated with one or more files for performance enhancement. In response, a memory system 110 may analyze whether a set of file data in each of the one or more files is physically contiguous or not. Then, the memory system 110 may transmit a message to the host system 105 indicating a result of the analysis of the set of file data. If the analysis indicates that the data is not physically contiguous, the memory system 110 may receive an FBO command from the host system 105, which may be an instruction to reorder the set of file data such that the set of file data is physically contiguous within the one or more files.

The term “AI” may be used to describe some types of operations (e.g., applications, procedures, or programs) supported by a host system 105. For example, the host system 105 (e.g., a device such as a mobile device, a computer, or the like) may support AI operations that include large language model (LLM) applications. In some cases, the host system 105 may use one or more neural networks or machine learning algorithms that support these AI operations. The host system 105 may support AI applications or programs such as computer vision programs, AI predictive modeling programs, AI virtual assistants, robotic control systems, or the like.

As described herein, a prefetch operation may refer to techniques to begin a data fetching operation whose result is expected to be used after a relatively short duration. The memory system 110 may perform a prefetch operation to move data from one or more memories to a cache of the memory system. A cache may be a location in memory of the memory system 110 that stores relatively high priority data (e.g., frequently used data). The memory system 110 may access the cache with increased speed compared to other memory locations (e.g., without using a large quantity of look-up tables or mapping tables). Thus, in some cases, the memory system 110 may prefetch data to a cache for quick, temporary access. In some examples, the memory system 110 may receive a prefetch command that includes one or more prefetch parameters. The one or more prefetch parameters may include an address associated with data, a size of the data, a priority associated with the data, a storage duration that the data is to be stored in the cache, an indicator for adjusting a cache size, and so on.

The system 100 may include any quantity of non-transitory computer readable media that support increased file loads using FBO and prefetch within a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

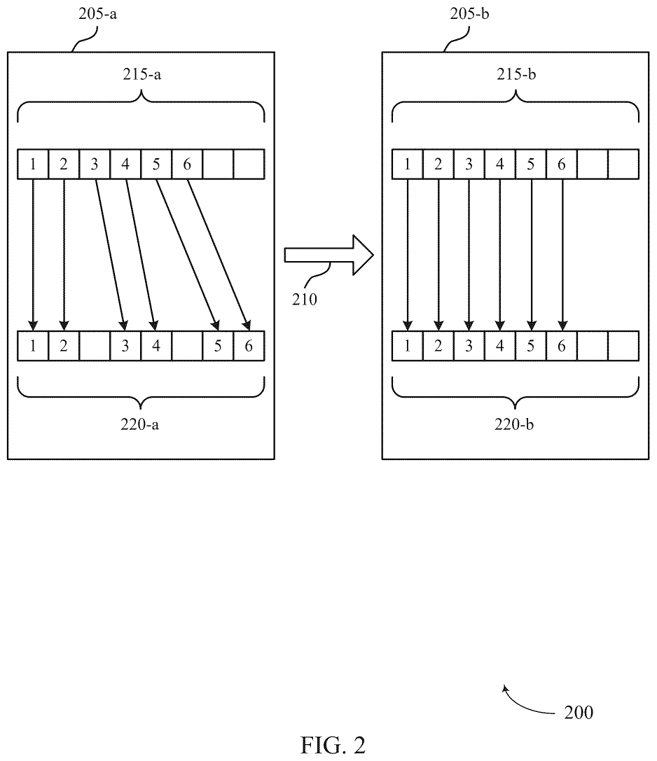

FIG. 2 shows an example of an optimization scheme 200 that supports increased file loads using FBO and prefetch within a memory system in accordance with examples as disclosed herein. The optimization scheme 200 may be an example of an FBO scheme. In some cases, the optimization scheme 200 may implement or be implemented by aspects of the system 100. For example, a memory system 110 may perform, using a memory system controller 115, one or more procedures to implement the optimization scheme 200. To perform these one or more procedures, the memory system controller 115 may include FBO logic 185 (e.g., one or more logic components and circuitry configured to facilitate the FBO scheme). Further, a host system 105 may send, to the memory system 110, a set of logical data elements in a logical data space 215. Thus, the memory system 110 may map the set of logical data elements in the logical data space 215 to a set of physical data elements in a physical data space 220 (e.g., according to the optimization scheme 200).

The optimization scheme 200 may illustrate a rearrangement of an L2P mapping (e.g., a logical block address to physical block address mapping) from a discontiguous mapping 205-a to a contiguous mapping 205-b through an FBO procedure 210. As described herein, the term “discontiguous” may refer to a set of data that is broken, interrupted, or not continuous, while the term “contiguous” may refer to a set of data that is unbroken, in sequence, without interruption, or continuous. The discontiguous mapping 205-a may illustrate a mapping between logical elements within a logical data space 215-a to physical elements within a physical data space 220-a. The logical data space 215-a may include a set of logical elements (e.g., logical elements 1, 2, 3, 4, and so on) that are logically contiguous. In accordance with the discontiguous mapping 205-a, the memory system 110 may map data within each logical element of the set of logical elements to a respective physical element of the physical data space 220-a such that the data is discontiguous within the physical data space 220-a. That is, the memory system 110 may map the data to available physical elements, even though the available physical elements may not be contiguous within the physical data space 220-a. In some examples, a portion of the data may be contiguous, but the entire set of data may be discontiguous within the physical data space 220-a.

The contiguous mapping 205-b may illustrate a mapping between logical elements within a logical data space 215-b to physical elements within a physical data space 220-b. The logical data space 215-b may include a set of logical elements (e.g., logical elements 1, 2, 3, 4, and so on) that are logically contiguous. In accordance with the contiguous mapping 205-b, the memory system 110 may map first data (e.g., AI-related data) within each logical element of the set of logical elements to a respective physical element of the physical data space 220-b such that the first data is contiguous within the physical data space 220-b. That is, the memory system 110 may allocate, for the first data, a set of physical elements within the physical data space 220-b that are contiguous. In some examples, this may include transferring valid data within the physical data space 220-b to a second physical data space 220 to free up space for the first data. Thus, the memory system 110 may apply the FBO procedure 210 to receive data from the host system 105 and map the data to a physically contiguous set of physical data elements, thereby reducing latency during memory reads by, for example, supporting a continuous read of all of the data at once, rather than multiple discontinuous reads to retrieve the data.

In some implementations, the memory system 110 may perform a combination of procedures, such as an FBO procedure and a prefetch procedure. As described herein, the term “prefetch” may be referred to as “pre-fetch”. For example, the host system 105 may send an FBO command for an AI model file (e.g., a file associated with an AI model) corresponding to one or more LBAs. The memory system 110 may defragment a file to a set of continuous memory cell blocks (e.g., a continuous TLC block or a continuous SLC area), for example, in cases where the memory system 110 has sufficient space in memory. In some cases, the host system 105 may send a prefetch command that includes an LBA range associated with the AI model file. In some examples, the memory system 110 may receive the prefetch command, and then may load the AI model file (e.g., receiving the prefetch command prior to loading the file).

In some implementations, the memory system 110 may maintain a pre-read associated with the AI model file in a cache for a relatively long duration (e.g., longer than a threshold duration, or longer than other storage durations associated with storing non-AI-related data). The AI model file may be capable of tolerating noise above a threshold noise level. For example, the memory system 110 may maintain the AI model file in a cache of the memory system 110, and may tolerate noise during read or write commands. In some cases, the memory system 110 may cache a pre-read buffer associated with the AI model file (e.g., if the memory system 110 has sufficient retention memory).

In some implementations, the memory system 110 may prioritize a read command associated with the AI model file (e.g., above other read commands). For example, if a read command indicates an address within a prefetch LBA range associated with the AI model file, the memory system 110 may prioritize the read command (e.g., the read command may have a first priority or a highest priority). In some cases, the memory system 110 may reserve a greater portion of read buffer for reading the AI model file (e.g., compared to portions of the read buffer allocated for other read commands). In some other cases, the host system 105 may apply other techniques associated with an LBA range (e.g., a “Fast LBA Range” feature) for the AI model file to improve efficiency of reading the AI model file.

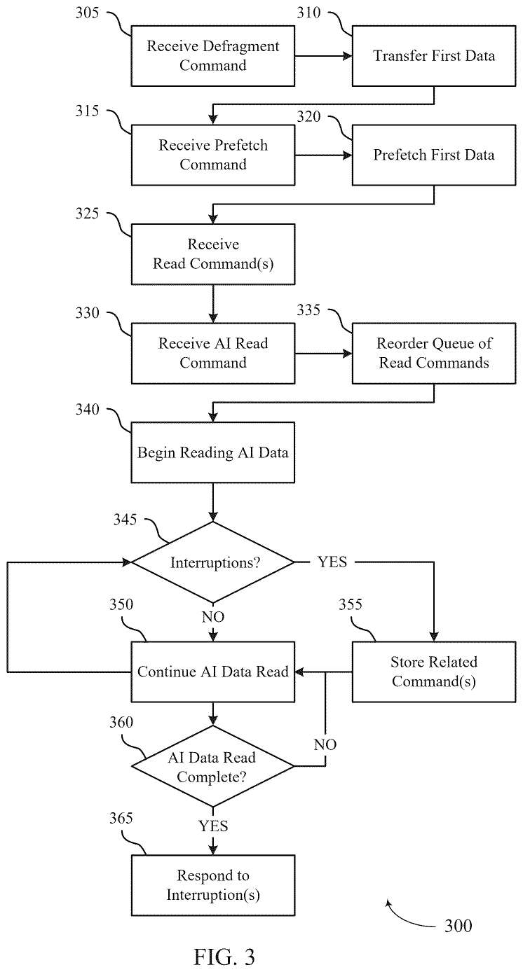

FIG. 3 shows an example of a flow diagram 300 that supports increased file loads using FBO and prefetch within a memory system in accordance with examples as disclosed herein. Aspects of the flow diagram 300 may be performed by a host system 105, a memory system 110, or both, which may be examples of the corresponding devices as described with respect to FIGS. 1 and 2. In the following description of the flow diagram 300, the operations described may be performed in a different order than the example order shown. Some operations may also be omitted from the flow diagram 300, and other operations may be added to the flow diagram 300. Further, although some operations may be shown to occur at different times for discussion purposes, these operations may actually occur at the same time. Aspects of the flow diagram 300 may be implemented by one or more controllers, among other components. Additionally, or alternatively, aspects of the flow diagram 300 may be implemented as instructions stored in one or more memories (e.g., firmware stored in one or more memories coupled with the memory system controller 115, the FBO logic 185, the prefetch logic 190, or any combination thereof). For example, the instructions, when executed by one or more controllers (e.g., the memory system controller 115), may cause the one or more controllers (or a device or a system) to perform the operations of the flow diagram 300.

At 305, a defragment command is received. For example, the memory system 110 may receive, from the host system 105, a command to defragment first data (e.g., AI-related data) stored in the memory system 110 in accordance with the first data being included in a single file. In some examples, the command may be referred to as an FBO command. For example, the first command may be an FBO command that indicates a logical address range corresponding to the single file. In some cases, the host system 105 may transmit the command to the memory system 110 in response to one or more messages (e.g., from the memory system 110) that indicate that the first data is discontiguous within the memory system 110.

At 310, the first data is transferred. For example, the memory system 110 may transfer the first data from one or more discontinuous ranges of physical addresses within the memory system 110 to a continuous range of physical addresses within the memory system 110.

At 315, a prefetch command is received. For example, the memory system 110 may receive, from the host system 105, a prefetch command to prefetch the first data stored in the memory system. In some cases, the prefetch command may indicate an address range associated with the first data and a first priority of the first data. For example, one or more bits or other indications within the prefetch command may indicate the first priority. In some examples, the first priority may be a higher priority than a set of priorities corresponding to other data stored in the memory system 110 in accordance with the first data including data associated with one or more AI applications. That is, the first priority may indicate that the first data includes AI-related data, that the first data is to be prefetched (and read) prior to other data, or both. In some examples, metadata or other information that indicates the first priority may be stored with or otherwise associated with the first data stored in the memory system 110.

At 320, the first data is prefetched. For example, the memory system 110 may prefetch the first data from one or more memory arrays within the memory system 110 to a cache of the memory system 110. In some examples, the memory system 110 may prefetch the first data in accordance with one or more prefetch parameters (e.g., indicated by the prefetch command). In some cases, the one or more prefetch parameters may be in accordance with the first priority of the first data. For example, the first priority of the data may indicate that the first data is to be prefetched with a highest priority, and so the one or more prefetch parameters may instruct the memory system 110 to prefetch the first data with the highest priority (e.g., with greater priority than, or before, other prefetch operations). The memory system 110 may, for example, reorder a command queue to prioritize the prefetch command for the first data, among other examples. In some cases, the memory system may prefetch the first data in accordance with the continuous range of physical addresses (e.g., in accordance with the range of physical address being continuous or contiguous).

In some implementations, the one or more prefetch parameters may include an increased cache space reserved for data having at least a threshold priority. Accordingly, the memory system 110 may prefetch the first data to the cache of the memory system 110 in accordance with the first priority of the first data being greater than the threshold priority. In some examples, the one or more prefetch parameters may include a threshold storage duration during which data having at least a threshold priority is configured to remain in the cache. Accordingly, the memory system 110 may perform operations such that the first data remains in the cache for at least the threshold storage duration in accordance with the first priority of the first data being greater than the threshold priority. The threshold storage duration may exceed other threshold storage durations associated with storing other data having other priorities that are less than the threshold priority. In some cases, the one or more prefetch parameters may include a reduced queue depth for prefetching the first data. The memory system 110 may prefetch the first data using the reduced queue depth in accordance with the first priority.

At 325, one or more read commands are received. For example, the memory system 110 may receive, from the host system 105 and before receiving a first read command, one or more second read commands associated with second data. In some cases, the memory system 110 may store the one or more second read commands in a queue of read commands at the memory system 110. The memory system 110 may execute commands from the queue in order (e.g., in the order in which the commands were put in the queue).

At 330, the first read command is received. For example, the memory system 110 may receive, from the host system 105, the first read command for the first data. In some examples, the first read command may be referred to as an AI read command (since the first data may be referred to as AI-related data). In some cases, the first read command may indicate the address range associated with the first data and the first priority of the first data.

At 335, the queue of read commands is reordered. For example, the memory system 110 may reorder the queue of read commands such that the first read command is to be executed before the one or more second read commands in accordance with the first priority being greater than one or more second priorities of the second data. In some examples, the host system 105 may transmit one or more parameters (e.g., the first priority or a list of priorities) to the memory system 110 indicating that the first read command is to be ordered first in the queue of read commands, or ordered before the one or more second read commands (e.g., since the one or more second read commands may have a lower priority than the first read command). Additionally, or alternatively, the memory system 110 may be configured with information that indicates the first priority, a threshold priority, or both, that are associated with reordering read commands and other operations for prioritization.

At 340, a read of the first data is initiated. For example, the memory system 110 may begin reading, in response to the first read command, the first data from the cache of the memory system 110. In some examples, a read size of the first data may be greater than respective read sizes of second data corresponding to the one or more second read commands in accordance with the first data comprising data associated with AI applications (e.g., since the first data may be AI-related data), the defragmentation of the first data, or both.

At 345, a set of interruptions may be monitored. For example, the memory system 110 may determine whether one or more interruptions are detected at the memory system 110. If the memory system 110 does not detect an interruption, at 350, the memory system 110 may continue reading the first data. In some cases, the memory system 110 may continue to monitor for interruptions during the read of the first data (e.g., continuously, periodically).

At 355, if one or more interruptions are detected at 345, one or more associated commands may be stored. For example, in some cases, the memory system 110 may receive (e.g., from the host system 105) one or more indications associated with one or more interruptions to reading of the first data, such as one or more other access commands received while reading the first data. In such cases, the memory system 110 may refrain from responding to the one or more interruptions until after the first data is successfully read from the cache in accordance with the first priority of the first data being greater than a threshold priority. In some examples, the threshold priority may be a highest priority among one or more respective priorities corresponding to the one or more interruptions or some other configured, indicated or default priority.

In some implementations, the memory system 110 may receive, from the host system 105 and while reading the first data, a second read command for second data stored in the memory system 110 or some other access command. The memory system 110 may store, in the command queue of the memory system, the second read command in accordance with reading the first data and in accordance with the first priority of the first data being greater than a second priority of the second data.

At 360, a completion of the read of the first data is determined. For example, the memory system 110 may monitor a status of a read of the first data (e.g., how much of the first data has not yet been read). If the memory system 110 determines that the read of the first data is incomplete, the memory system 110 may continue the read of the first data (e.g., proceeding to or remaining at 350). If the memory system 110 determines that the read of the first data is complete (e.g., after completing the first data), the memory system 110 may proceed to 365 to respond to interruptions.

At 365, one or more interruptions may be addressed. For example, the memory system 110 may respond to the one or more interruptions detected during the read of the first data. In some examples, the memory system 110 may read, in accordance with the second read command (or one or more second read commands), the second data after the reading the first data from the cache of the memory system.

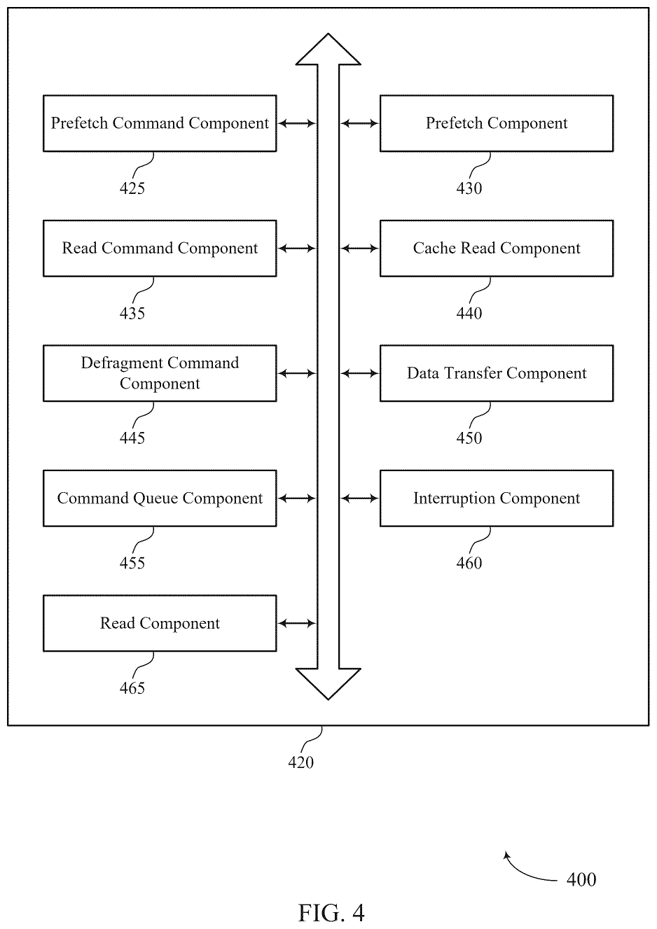

FIG. 4 shows a block diagram 400 of a memory system 420 that supports increased file loads using FBO and prefetch within a memory system in accordance with examples as disclosed herein. The memory system 420 may be an example of aspects of a memory system as described with reference to FIGS. 1 through 3. The memory system 420, or various components thereof, may be an example of means for performing various aspects of increased file loads using FBO and prefetch within a memory system as described herein. For example, the memory system 420 may include a prefetch command component 425, a prefetch component 430, a read command component 435, a cache read component 440, a defragment command component 445, a data transfer component 450, a command queue component 455, an interruption component 460, a read component 465, or any combination thereof. Each of these components, or components of subcomponents thereof (e.g., one or more processors, one or more memories), may communicate, directly or indirectly, with one another (e.g., via one or more buses).

The prefetch command component 425 may be configured as or otherwise support a means for receiving a prefetch command to prefetch first data stored in a memory system, where the prefetch command indicates an address range associated with the first data and a first priority of the first data. The prefetch component 430 may be configured as or otherwise support a means for prefetching, in accordance with one or more prefetch parameters, the first data from one or more memory arrays within the memory system to a cache of the memory system, where the one or more prefetch parameters are in accordance with the first priority of the first data. The read command component 435 may be configured as or otherwise support a means for receiving a first read command for the first data, where the first read command indicates the address range associated with the first data and the first priority of the first data. The cache read component 440 may be configured as or otherwise support a means for reading, in response to the first read command, the first data from the cache of the memory system.

In some examples, the defragment command component 445 may be configured as or otherwise support a means for receiving a command to defragment the first data in accordance with the first data being included in a single file. In some examples, the data transfer component 450 may be configured as or otherwise support a means for transferring the first data from one or more discontinuous ranges of physical addresses within the memory system to a continuous range of physical addresses within the memory system, where prefetching the first data is in accordance with the continuous range of physical addresses.

In some examples, the command includes an FBO command that indicates a logical address range corresponding to the single file.

In some examples, the read command component 435 may be configured as or otherwise support a means for receiving, before receiving the first read command, one or more second read commands associated with second data, where the one or more second read commands and the first read command for the first data are stored in a queue of read commands at the memory system. In some examples, the command queue component 455 may be configured as or otherwise support a means for reordering the queue of read commands such that the first read command is to be executed before the one or more second read commands in accordance with the first priority being greater than one or more second priorities of the second data.

In some examples, the interruption component 460 may be configured as or otherwise support a means for receiving one or more indications associated with one or more interruptions to the reading of the first data. In some examples, the cache read component 440 may be configured as or otherwise support a means for refraining from responding to the one or more interruptions until after the first data is successfully read from the cache in accordance with the first priority of the first data being greater than a threshold priority.

In some examples, to support receiving the one or more indications, the read command component 435 may be configured as or otherwise support a means for receiving, while reading the first data, a second read command for second data stored in the memory system. In some examples, to support receiving the one or more indications, the command queue component 455 may be configured as or otherwise support a means for storing, in a command queue of the memory system, the second read command in accordance with reading the first data and the first priority of the first data being greater than a second priority of the second data. In some examples, to support receiving the one or more indications, the read component 465 may be configured as or otherwise support a means for reading, in accordance with the second read command, the second data after the reading the first data from the cache of the memory system.

In some examples, the first priority includes a higher priority than a set of priorities corresponding to other data stored in the memory system in accordance with the first data including data associated with one or more artificial intelligence applications.

In some examples, the one or more prefetch parameters include an increased cache space reserved for data having at least a threshold priority. In some examples, the first data is prefetched to the cache of the memory system in accordance with the first priority of the first data being greater than the threshold priority.

In some examples, the one or more prefetch parameters include a threshold storage duration during which data having at least a threshold priority is configured to remain in the cache. In some examples, the first data remains in the cache for at least the threshold storage duration in accordance with the first priority of the first data being greater than the threshold priority. In some examples, the threshold storage duration exceeds other threshold storage durations associated with storing other data having other priorities that are less than the threshold priority.

In some examples, the one or more prefetch parameters include a reduced queue depth for prefetching the first data and in accordance with the first priority.

In some examples, a read size of the first data is greater than respective read sizes of second data corresponding to one or more second read commands in accordance with the first data including data associated with artificial intelligence applications.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

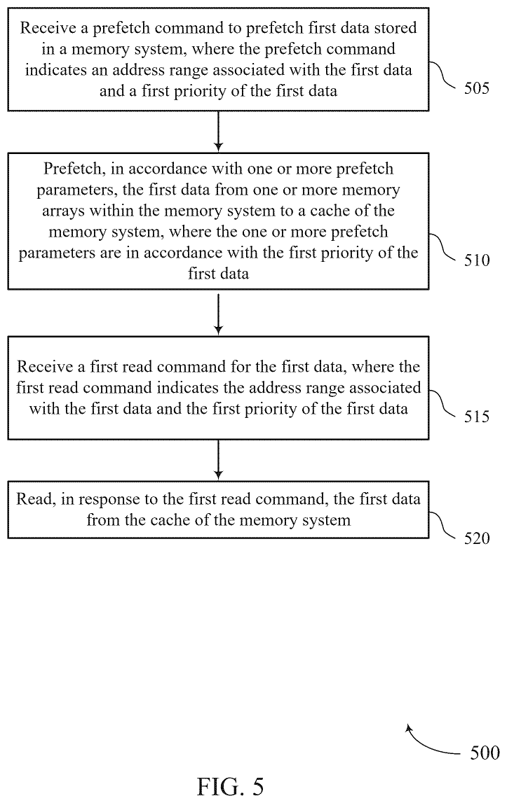

FIG. 5 shows a flowchart illustrating a process 500 that supports increased file loads using FBO and prefetch within a memory system in accordance with examples as disclosed herein. The operations of process 500 may be implemented by a memory system or its components as described herein. For example, the operations of process 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the process may include receiving a prefetch command to prefetch first data stored in a memory system, where the prefetch command indicates an address range associated with the first data and a first priority of the first data. In some examples, aspects of the operations of 505 may be performed by a prefetch command component 425 as described with reference to FIG. 4.

At 510, the process may include prefetching, in accordance with one or more prefetch parameters, the first data from one or more memory arrays within the memory system to a cache of the memory system, where the one or more prefetch parameters are in accordance with the first priority of the first data. In some examples, aspects of the operations of 510 may be performed by a prefetch component 430 as described with reference to FIG. 4.

At 515, the process may include receiving a first read command for the first data, where the first read command indicates the address range associated with the first data and the first priority of the first data. In some examples, aspects of the operations of 515 may be performed by a read command component 435 as described with reference to FIG. 4.

At 520, the process may include reading, in response to the first read command, the first data from the cache of the memory system. In some examples, aspects of the operations of 520 may be performed by a cache read component 440 as described with reference to FIG. 4.

In some examples, an apparatus as described herein may perform a process or processes, such as the process 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a prefetch command to prefetch first data stored in a memory system, where the prefetch command indicates an address range associated with the first data and a first priority of the first data; prefetching, in accordance with one or more prefetch parameters, the first data from one or more memory arrays within the memory system to a cache of the memory system, where the one or more prefetch parameters are in accordance with the first priority of the first data; receiving a first read command for the first data, where the first read command indicates the address range associated with the first data and the first priority of the first data; and reading, in response to the first read command, the first data from the cache of the memory system.

Aspect 2: The method, apparatus, or non-transitory computer-readable medium of aspect 1, further including operations, features, circuitry, logic, means, or instructions, or any combination thereof for receiving a command to defragment the first data in accordance with the first data being included in a single file and transferring the first data from one or more discontinuous ranges of physical addresses within the memory system to a continuous range of physical addresses within the memory system, where prefetching the first data is in accordance with the continuous range of physical addresses.

Aspect 3: The method, apparatus, or non-transitory computer-readable medium of aspect 2, where the command includes an FBO command that indicates a logical address range corresponding to the single file.

Aspect 4: The method, apparatus, or non-transitory computer-readable medium of any of aspects 1 through 3, further including operations, features, circuitry, logic, means, or instructions, or any combination thereof for receiving, before receiving the first read command, one or more second read commands associated with second data, where the one or more second read commands and the first read command for the first data are stored in a queue of read commands at the memory system and reordering the queue of read commands such that the first read command is to be executed before the one or more second read commands in accordance with the first priority being greater than one or more second priorities of the second data.

Aspect 5: The method, apparatus, or non-transitory computer-readable medium of any of aspects 1 through 4, further including operations, features, circuitry, logic, means, or instructions, or any combination thereof for receiving one or more indications associated with one or more interruptions to the reading of the first data and refraining from responding to the one or more interruptions until after the first data is successfully read from the cache in accordance with the first priority of the first data being greater than a threshold priority.

Aspect 6: The method, apparatus, or non-transitory computer-readable medium of aspect 5, where receiving the one or more indications includes operations, features, circuitry, logic, means, or instructions, or any combination thereof for receiving, while reading the first data, a second read command for second data stored in the memory system; storing, in a command queue of the memory system, the second read command in accordance with reading the first data and the first priority of the first data being greater than a second priority of the second data; and reading, in accordance with the second read command, the second data after the reading the first data from the cache of the memory system.

Aspect 7: The method, apparatus, or non-transitory computer-readable medium of any of aspects 1 through 6, where the first priority includes a higher priority than a set of priorities corresponding to other data stored in the memory system in accordance with the first data including data associated with one or more artificial intelligence applications.

Aspect 8: The method, apparatus, or non-transitory computer-readable medium of any of aspects 1 through 7, where the one or more prefetch parameters include an increased cache space reserved for data having at least a threshold priority and the first data is prefetched to the cache of the memory system in accordance with the first priority of the first data being greater than the threshold priority.

Aspect 9: The method, apparatus, or non-transitory computer-readable medium of any of aspects 1 through 8, where the one or more prefetch parameters include a threshold storage duration during which data having at least a threshold priority is configured to remain in the cache; the first data remains in the cache for at least the threshold storage duration in accordance with the first priority of the first data being greater than the threshold priority; and the threshold storage duration exceeds other threshold storage durations associated with storing other data having other priorities that are less than the threshold priority.

Aspect 10: The method, apparatus, or non-transitory computer-readable medium of any of aspects 1 through 9, where the one or more prefetch parameters include a reduced queue depth for prefetching the first data and in accordance with the first priority.

Aspect 11: The method, apparatus, or non-transitory computer-readable medium of any of aspects 1 through 10, where a read size of the first data is greater than respective read sizes of second data corresponding to one or more second read commands in accordance with the first data including data associated with artificial intelligence applications.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a prefetch command to prefetch first data stored in the memory system, wherein the prefetch command indicates an address range associated with the first data and a first priority of the first data;
prefetch, in accordance with one or more prefetch parameters, the first data from one or more memory arrays within the memory system to a cache of the memory system, wherein the one or more prefetch parameters are in accordance with the first priority of the first data;
receive a first read command for the first data, wherein the first read command indicates the address range associated with the first data and the first priority of the first data; and
read, in response to the first read command, the first data from the cache of the memory system.

2. The memory system of claim 1, wherein the processing circuitry is further configured to cause the memory system to:
receive a command to defragment the first data in accordance with the first data being included in a single file; and
transfer the first data from one or more discontinuous ranges of physical addresses within the memory system to a continuous range of physical addresses within the memory system, wherein prefetching the first data is in accordance with the continuous range of physical addresses.

3. The memory system of claim 2, wherein the command comprises a file based optimization command that indicates a logical address range corresponding to the single file.

4. The memory system of claim 1, wherein the processing circuitry is further configured to cause the memory system to:
receive, before receiving the first read command, one or more second read commands associated with second data, wherein the one or more second read commands and the first read command for the first data are stored in a queue of read commands at the memory system; and
reorder the queue of read commands such that the first read command is to be executed before the one or more second read commands in accordance with the first priority being greater than one or more second priorities of the second data.

5. The memory system of claim 1, wherein the processing circuitry is further configured to cause the memory system to:
receive one or more indications associated with one or more interruptions to the reading of the first data; and
refrain from responding to the one or more interruptions until after the first data is successfully read from the cache in accordance with the first priority of the first data being greater than a threshold priority.

6. The memory system of claim 5, wherein, to receive the one or more indications, the processing circuitry is configured to cause the memory system to:
receive, while reading the first data, a second read command for second data stored in the memory system;
store, in a command queue of the memory system, the second read command in accordance with reading the first data and the first priority of the first data being greater than a second priority of the second data; and
read, in accordance with the second read command, the second data after the reading the first data from the cache of the memory system.

7. The memory system of claim 1, wherein the first priority comprises a higher priority than a set of priorities corresponding to other data stored in the memory system in accordance with the first data comprising data associated with one or more artificial intelligence applications.

8. The memory system of claim 1, wherein:
the one or more prefetch parameters comprise an increased cache space reserved for data having at least a threshold priority, and
the first data is prefetched to the cache of the memory system in accordance with the first priority of the first data being greater than the threshold priority.

9. The memory system of claim 1, wherein:
the one or more prefetch parameters comprise a threshold storage duration during which data having at least a threshold priority is configured to remain in the cache,
the first data remains in the cache for at least the threshold storage duration in accordance with the first priority of the first data being greater than the threshold priority, and
the threshold storage duration exceeds other threshold storage durations associated with storing other data having other priorities that are less than the threshold priority.

10. The memory system of claim 1, wherein the one or more prefetch parameters comprise a reduced queue depth for prefetching the first data and in accordance with the first priority.

11. The memory system of claim 1, wherein a read size of the first data is greater than respective read sizes of second data corresponding to one or more second read commands in accordance with the first data comprising data associated with artificial intelligence applications.

12. A non-transitory computer-readable medium storing code comprising instructions which, when executed by one or more processors of a memory system, cause the memory system to:
receive a prefetch command to prefetch first data stored in a memory system, wherein the prefetch command indicates an address range associated with the first data and a first priority of the first data;
prefetch, in accordance with one or more prefetch parameters, the first data from one or more memory arrays within the memory system to a cache of the memory system, wherein the one or more prefetch parameters are in accordance with the first priority of the first data;
receive a first read command for the first data, wherein the first read command indicates the address range associated with the first data and the first priority of the first data; and
read, in response to the first read command, the first data from the cache of the memory system.

13. The non-transitory computer-readable medium of claim 12, wherein the instructions, when executed by the one or more processors of the memory system, further cause the memory system to:
receive a command to defragment the first data in accordance with the first data being included in a single file; and
transfer the first data from one or more discontinuous ranges of physical addresses within the memory system to a continuous range of physical addresses within the memory system, wherein prefetching the first data is in accordance with the continuous range of physical addresses.

14. The non-transitory computer-readable medium of claim 12, wherein the instructions, when executed by the one or more processors of the memory system, further cause the memory system to:
receive, before receiving the first read command, one or more second read commands associated with second data, wherein the one or more second read commands and the first read command for the first data are stored in a queue of read commands at the memory system; and
reorder the queue of read commands such that the first read command is to be executed before the one or more second read commands in accordance with the first priority being greater than one or more second priorities of the second data.

15. The non-transitory computer-readable medium of claim 12, wherein the instructions, when executed by the one or more processors of the memory system, further cause the memory system to:
receive one or more indications associated with one or more interruptions to the reading of the first data; and
refrain from responding to the one or more interruptions until after the first data is successfully read from the cache in accordance with the first priority of the first data being greater than a threshold priority.

16. The non-transitory computer-readable medium of claim 15, wherein the instructions to receive the one or more indications, when executed by the one or more processors of the memory system, cause the memory system to:
receive, while reading the first data, a second read command for second data stored in the memory system;
store, in a command queue of the memory system, the second read command in accordance with reading the first data and the first priority of the first data being greater than a second priority of the second data; and
read, in accordance with the second read command, the second data after the reading the first data from the cache of the memory system.

17. A method, comprising:
receiving a prefetch command to prefetch first data stored in a memory system, wherein the prefetch command indicates an address range associated with the first data and a first priority of the first data;
prefetching, in accordance with one or more prefetch parameters, the first data from one or more memory arrays within the memory system to a cache of the memory system, wherein the one or more prefetch parameters are in accordance with the first priority of the first data;
receiving a first read command for the first data, wherein the first read command indicates the address range associated with the first data and the first priority of the first data; and
reading, in response to the first read command, the first data from the cache of the memory system.

18. The method of claim 17, further comprising:
receiving a command to defragment the first data in accordance with the first data being included in a single file; and
transferring the first data from one or more discontinuous ranges of physical addresses within the memory system to a continuous range of physical addresses within the memory system, wherein prefetching the first data is in accordance with the continuous range of physical addresses.

19. The method of claim 18, wherein the command comprises a file based optimization command that indicates a logical address range corresponding to the single file.

20. The method of claim 17, further comprising:
receiving, before receiving the first read command, one or more second read commands associated with second data, wherein the one or more second read commands and the first read command for the first data are stored in a queue of read commands at the memory system; and
reordering the queue of read commands such that the first read command is to be executed before the one or more second read commands in accordance with the first priority being greater than one or more second priorities of the second data.

21. The method of claim 17, further comprising:
receiving one or more indications associated with one or more interruptions to the reading of the first data; and
refraining from responding to the one or more interruptions until after the first data is successfully read from the cache in accordance with the first priority of the first data being greater than a threshold priority.

22. The method of claim 21, wherein receiving the one or more indications comprises:
receiving, while reading the first data, a second read command for second data stored in the memory system;
storing, in a command queue of the memory system, the second read command in accordance with reading the first data and the first priority of the first data being greater than a second priority of the second data; and
reading, in accordance with the second read command, the second data after the reading the first data from the cache of the memory system.
